(19) United States
(12) Patent Application Publication
(10) Pub. No.: US 2005/0138331 A1
(43) Pub. Date: Jun. 23, 2005

(54) Direct memory access unit with instruction pre-decoder

(76) Inventors: Carl A. Alberola, San Diego, CA (US); Amit R. Gupta, Los Altos, CA (US); Tsung-Hsin Lu, Fremont, CA (US)

Correspondence Address: BUCKLEY, MASCHOFF, TALWALKAR LLC, 5 ELM STREET, NEW CANAAN, CT, 06840, US

(21) Appl. No.: 10/743,121

(22) Filed: Dec. 22, 2003

(51) Int. Cl. G06F 9/30

(52) U.S. Cl. 712/213

(57) ABSTRACT

According to some embodiments, an instruction is pre-decoded at a direct memory access unit.

### BACKGROUND

A processor may execute instructions using an instruction pipeline. The processor pipeline might include, for example, stages to fetch an instruction, to decode the instruction, and to execute the instruction. While the processor executes an instruction in the execution stage, the next sequential instruction can be simultaneously decoded in the decode stage (and the instruction after that can be simultaneously fetched in the fetch stage). Note that each stage may be associated with more than one clock cycle (e.g., the decode stage could include a pre-decode stage and a decode stage, each of these stages being associated with one clock cycle). Because different pipeline stages can simultaneously work on different instructions, the performance of the processor may be improved.

After an instruction is decoded, however, the processor might determine that the next sequential instruction should not be executed (e.g., when the decoded instruction is associated with a jump or branch instruction). In this case, instructions that are currently in the decode and fetch stages may be removed from the pipeline. This situation, referred to as a “branch misprediction penalty,” may reduce the performance of the processor.

### BRIEF DESCRIPTION OF THE DRAWINGS

FIG. 1 is a block diagram of an apparatus.

FIG. 2 illustrates instruction pipeline stages.

FIG. 3 is a block diagram of an apparatus according to some embodiments.

FIG. 4 is a method according to some embodiments.

FIG. 5 illustrates instruction pipeline stages according to some embodiments.

FIG. 6 is an example of an apparatus according to some embodiments.

FIG. 7 is a block diagram of a system according to some embodiments.

### DETAILED DESCRIPTION

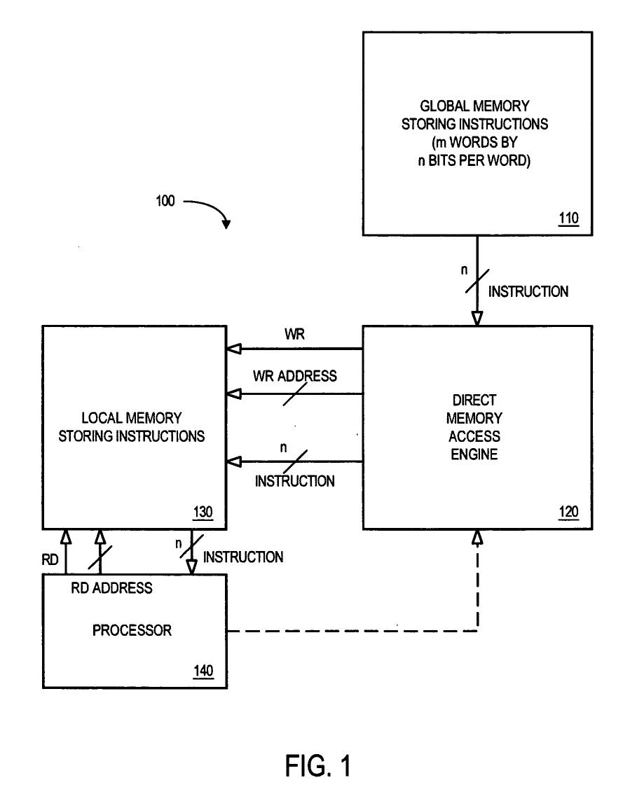

FIG. 1 is a block diagram of an apparatus 100 that includes a global memory 110 to store instructions (e.g., instructions that are loaded into the global memory 110 during a boot-up process). The global memory 110 may, for example, store m words (e.g., 100,000 words) with each word having n bits (e.g., 32 bits).

A Direct Memory Access (DMA) engine 120 may sequentially retrieve instructions from the global memory 110 and transfer the instructions to a local memory 130 at a processing element (e.g., to the processing element's cache memory). For example, an n-bit input path to the DMA engine 120 may be used to retrieve an instruction from the global memory 110. The DMA engine 120 may then use a write signal (WR) and a write address (WR ADDRESS) to transfer the instruction to the local memory 130 via an n-bit output path.

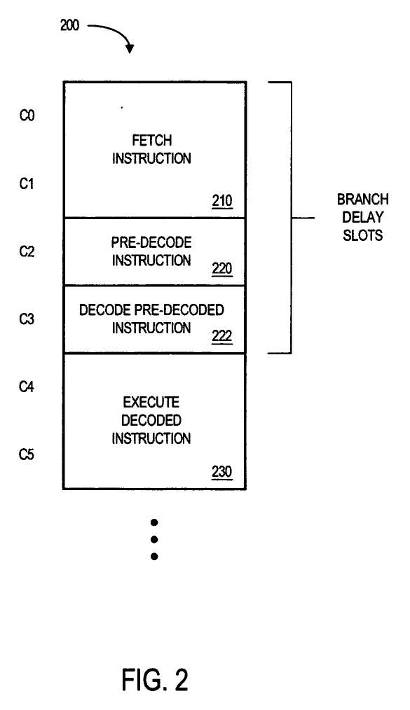

A processor 140 can then use a read signal (RD) and a read address (RD ADDRESS) to retrieve sequential instructions from the local memory 130 via an n-bit path. The processor 140 may then execute the instructions. To improve performance, the processor 140 may execute instructions using the instruction pipeline 200 illustrated in FIG. 2. While the processor 140 executes an instruction in an execution stage 230, the next sequential instruction is simultaneously decoded in decode stages 220, 222 (and the instruction after that is simultaneously fetched in a fetch stage 210).

Note that a single stage may be associated with more than one clock cycle, especially at relatively high clock rates. For example, in the pipeline 200 illustrated in FIG. 2 two clock cycles are required to fetch an instruction (C0 and C1). Similarly, decoding an instruction requires one clock cycle (C2) to partially translate an instruction into a “pre-decoded” instruction and another clock cycle (C3) to convert the pre-decoded instruction into a completely decoded instruction that can be executed.

After an instruction is decoded, the processor 140 might determine that the next sequential instruction will not be executed (e.g., when the decoded instruction is associated with a jump or branch instruction). In this, case, instructions that are currently in the decode stages 220, 222 and the fetch stage 210 may be removed from the pipeline 200. The clock cycles that are wasted as a result of fetching and decoding an instruction that will not be executed are referred to as “branch delay slots.”

Reducing the number of branch delay slots may improve the performance of the processor 140. For example, if partially or completely decoded instructions were stored in the global memory 110, the pre-decode stages 220 could be removed from pipeline 200 and the number of branch delay slots would be reduced. The pre-decoded instructions, however, would be significantly larger than the original instruction. For example, a 32-bit instruction might have one hundred bits after it is decoded. As a result, it may be impractical to store decoded instructions in the global memory 110 (e.g., because the memory area that would be required would be too large).

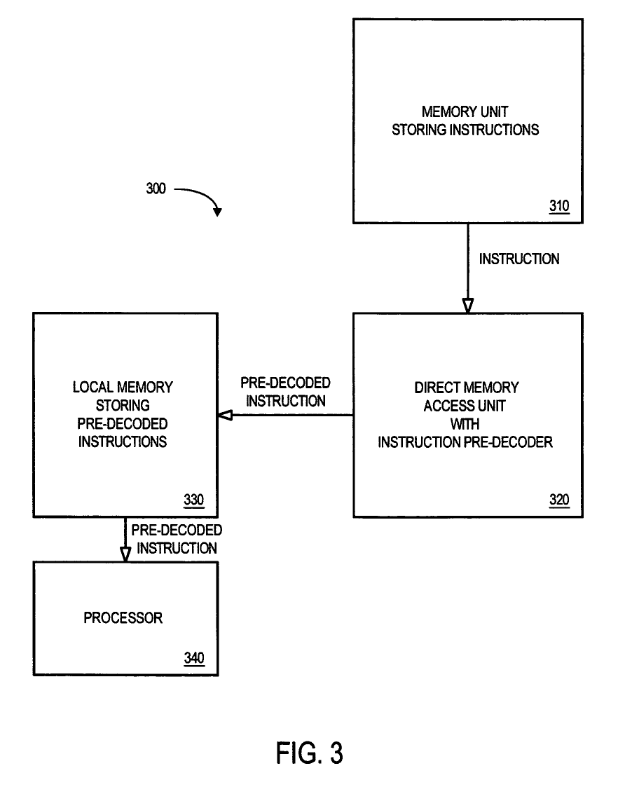

FIG. 3 is a block diagram of an apparatus 300 according to some embodiments. As before, a DMA unit 320 sequentially retrieves instructions from a memory unit 310 via an input path. According to this embodiment, however, the DMA unit 320 also includes an instruction pre-decoder to pre-decode the instruction.

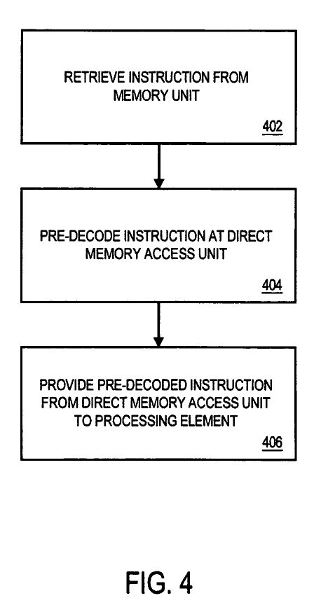

FIG. 4 is a method that may be performed by the DMA unit 320 according to some embodiments. Note that any of the methods described herein may be performed by hardware, software (including microcode), or a combination of hardware and software. For example, a storage medium may store thereon instructions that when executed by a machine result in performance according to any of the embodiments described herein.

At 402, an instruction is retrieved from the memory unit 310. The DMA unit 320 then pre-decodes the instruction at 404. The DMA unit 320 may, for example, partially or completely decode the instruction. At 406, the pre-decoded instruction is provided from the DMA unit 320 to a local memory 330 at a processing element.

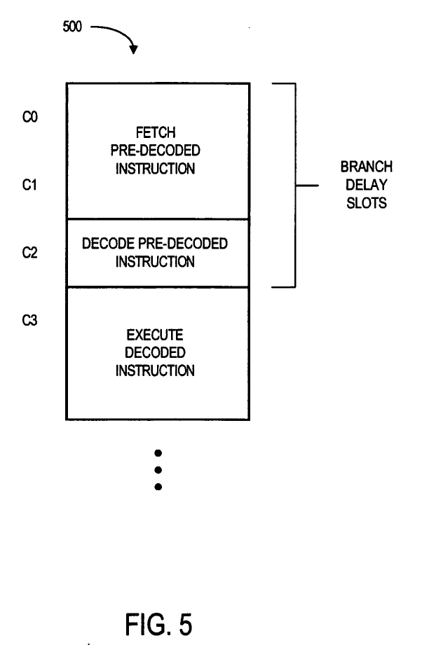

Referring again to FIG. 3, a processor 340 can then retrieve the pre-decoded instruction from the local memory 330 and execute the instruction. FIG. 5 illustrates an instruction pipeline 500 according to some embodiments. Because the DMA unit 320 already pre-decoded the instruction, the number of clock cycles required for the processor 340 to generate a completely decoded instruction (the branch delay slots CO through C2) may be reduced as compared to FIG. 2, and the performance of the processor 340 may be improved. Moreover, since only the local memory 330 needs to be large enough to store pre-decoded instructions (and the memory unit 310 still stores the smaller, original instructions), the resulting increase in memory area may be limited. If the DMA unit 320 completely decodes an instruction, the number of branch delay slots may be reduced even further (although the size of the local memory 330 might need to be increased further to store a fully decoded instruction).

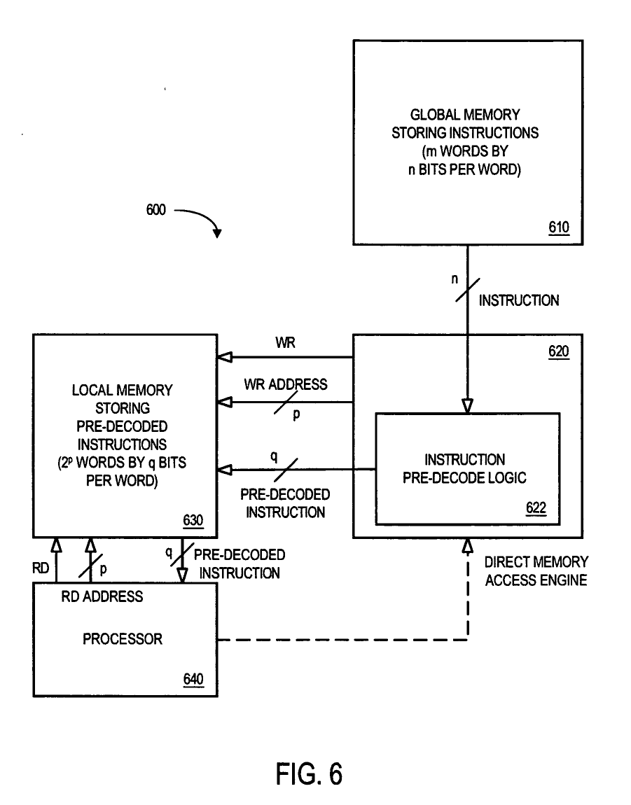

FIG. 6 is an example of an apparatus 600 that includes a global memory 610 to store n-bit instructions according to some embodiments. A DMA engine 620 sequentially retrieves the instructions and instruction pre-decode logic 622 pre-decodes each instruction to generate a q-bit pre-decoded instruction (e.g., on cache misses or by software-controlled DMA commands).

The DMA engine 620 may then use a write signal (WR) and a p-bit write address (WR ADDRESS) to transfer the pre-decoded instruction to a local memory 630 via a q-bit output path. The local memory 630 may be, for example, a processor cache that can store 2^{p} words that have been pre-decoded (e.g., a ten-bit write address could access 1,024 instructions). Note that because the instruction has been pre-decoded, q may be larger than n (e.g., because the pre-decoded instruction is larger than the original instruction). The pre-decoded instructions stored in the local memory 630 may comprise, for example, execution unit control signals and/or flags.

A processor 140 may then use a read signal (RD) and a p-bit read address (RD ADDRESS) to retrieve pre-decoded instructions from the local memory 630 via a q-bit path. The processor 640 may comprise, for example, a Reduced Instruction Set Computer (RISC) device that executes instructions using fewer pipeline stages as compared to FIG. 2 (e.g., because at least some of the branch delay slots associated with decoding are no longer required).

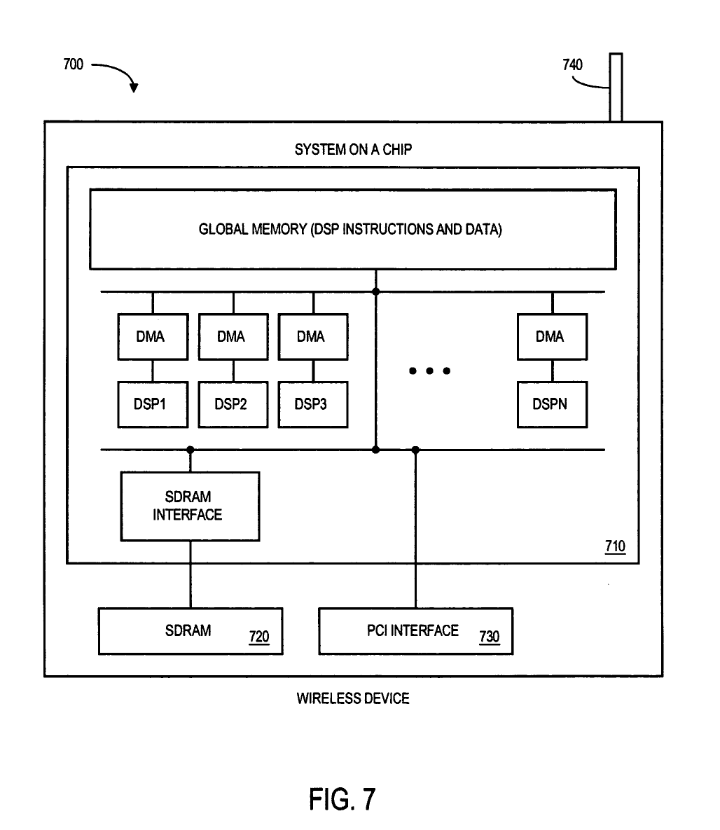

FIG. 7 is a block diagram of a system 700 according to some embodiments. In particular, the system 700 is a wireless device with a multi-directional antenna 740. The system 700 may be, for example, a Code-Division Multiple Access (CDMA) base station.

The wireless device includes a System On a Chip (SOC) apparatus 710, a Synchronous Dynamic Random Access Memory (SDRAM) unit 720, and a Peripheral Component Interconnect (PCI) interface unit 730, such as a unit that operates in accordance with the PCI Standards Industry Group (SIG) document entitled “PCI Express 1.0” (2002). The SOC apparatus 710 may be, for example, a digital base band processor with a global memory that stores Digital Signal Processor (DSP) instructions and data. Moreover, multiple DMA engines may retrieve instructions from the global memory, pre-decode the instructions, and provide pre-decoded instructions to multiple DSPs (e.g., DSP1 through DSPN) in accordance with any of the embodiments described herein.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described wherein a DMA unit includes an internal instruction pre-decoder, the instruction pre-decoder could instead be external to the DMA unit. For example, a unit external to the DMA unit may partially or completely decode an instruction as it is “in-flight” from a memory external to the processing element. Moreover, although some embodiments have been described with a SOC implementation, some or all of the elements described herein might be implemented using multiple integrated circuits.

The several embodiments described herein are solely for the purpose of illustration. Persons skilled in the art will recognize from this description other embodiments may be practiced with modifications and alterations limited only by the claims.

1. A method, comprising:
retrieving an instruction from a memory unit;
pre-decoding the instruction at a direct memory access unit; and
providing the pre-decoded instruction from the direct memory access unit to a processing element.

2. The method of claim 1, wherein said providing comprises storing the pre-decoded instruction in memory local to the processing element.

3. The method of claim 2, wherein the pre-decoded instruction is a completely decoded instruction to be executed by the processing element.

4. The method of claim 1, further comprising:
decoding the pre-decoded instruction at the processing element; and
executing the decoded instruction via a processor pipeline.

5. The method of claim 1, further comprising:
loading instructions into the memory unit during a boot-up process.

6. The method of claim 1, wherein the processing element is a reduced instruction set computer device.

7. The method of claim 6, wherein the pre-decoded instruction comprises execution control signals.

8. An apparatus, comprising:
an input path to receive an instruction from a memory unit;
a direct memory access unit including an instruction pre-decoder to pre-decode the instruction; and
an output path to provide a pre-decoded instruction from the direct memory access unit to a processing element.

9. The apparatus of claim 8, further comprising:
the memory unit coupled to the input path.

10. The apparatus of claim 9, further comprising:
the processing element coupled to the output path.

11. The apparatus of claim 10, wherein the processing element includes a local memory to store the pre-decoded instruction.

12. The apparatus of claim 10, including a plurality of processing elements, each processing element being associated with a direct memory access unit that includes an instruction pre-decoder.

13. The apparatus of claim 10, wherein the input path has n bits, the output path has q bits, and n<q.

14. The apparatus of claim 10, wherein the direct memory access unit, the memory unit, and the processing element are formed on an integrated circuit.

15. The apparatus of claim 10, wherein the processing element is a reduced instruction set computer device having an instruction pipeline.

16. An article, comprising:
a storage medium having stored thereon instructions that when executed by a machine result in the following:
retrieving an instruction from a memory unit,
pre-decoding the instruction at a direct memory access unit, and
providing the pre-decoded instruction from the direct memory access unit to a processing element.

17. The article of claim 16, wherein said providing comprises storing the pre-decoded instruction in memory local to the processing element.

18. An apparatus, including:
a global memory to store instructions;
an instruction pre-decoder; and
a processor, wherein the instruction pre-decoder is to pre-decode an instruction as it is being transferred from the global memory to the processor.

19. The apparatus of claim 18, further comprising:
a direct memory access unit to arrange for the instruction to be retrieved from the global memory unit and to arrange for a pre-decoded instruction to be provided to the processor.

20. The apparatus of claim 18, wherein a pre-decoded instruction comprises execution control signals.

21. A system, comprising:
a multi-directional antenna; and
an apparatus having a direct memory access unit that includes:
an input path to receive an instruction from a memory unit,
an instruction pre-decoder to pre-decode the instruction, and
an output path to provide a pre-decoded instruction to a processing element.

22. The system of claim 21, wherein the apparatus is a digital base band processor.

23. The system of claim 22, wherein the digital base band processor is formed as a system on a chip.

24. The system of claim 21, wherein the system is a code-division multiple access base station.
